(19) United States
(12) Patent Application Publication
(10) Pub. No.: US 2014/0049141 A1
(43) Pub. Date: Feb. 20, 2014

(54) Multi-Use Modular Furniture with Storage

(71) Applicants: Gita J. Patel, Monmouth Junction, NJ (US); Jitendra S. Patel, Monmouth Junction, NJ (US)

(72) Inventors: Gita J. Patel, Monmouth Junction, NJ (US); Jitendra S. Patel, Monmouth Junction, NJ (US)

(21) Appl. No.: 13/587,899

(22) Filed: Aug. 16, 2012

(51) Int. Cl. A47B 87/00; B23P 11/00

(52) U.S. Cl. 312/111; 312/107; 29/428

(57) ABSTRACT

A modular furniture system is described. The system includes a base component having a cavity and at least one base connector, at least one flexible side panel adapted to connect to the base component, each flexible side panel including at least one first connecting region adapted to be secured to the cavity of the base component and at least one second connecting region, a top support component comprising a cavity adapted to be secured to the at least one second connecting region, and a lid adapted to be coupled to the top support component. A modular furniture device is also described. The device includes a base component and top support component, each with at least one cavity and multiple slots, and at least one side panel. Each side panel includes multiple connecting regions with tabs able to be connected to slots included in the base or top support component.

### BACKGROUND

Modular furniture, sometimes also known as ready-to-assemble furniture, generally refers to furniture that is assembled from basic modules. Such modules, in combination, form a basic assembly that meets some required functional elements. The modules can be manipulated by a user to provide different configurations, which can vary in terms of size, utility, design, color, etc. Many may use modular furniture because it can be easy to transport, can fit in various environments, and can be easily assembled.

With existing modular furniture solutions, the finished product is typically permanently fastened together in the desired configuration. A problem with these solutions is that the resulting structure is relatively weak and therefore subject to being damaged. Traditional modular furniture systems also do not generally allow for quick and easy reconfiguration to suit changing needs, tastes, environments, etc.

Accordingly, there is a need for modular furniture that is structurally secure, easily assembled and disassembled, and that retains its strength in different configurations.

### BRIEF SUMMARY

Some embodiments provide a way to store various articles and/or materials and/or to provide various furniture items. The present invention may provide various structural components that may be assembled to form a structure and subsequently disassembled into component pieces. Such a structure may be configured in various different ways (e.g., different heights, widths and/or radii, load capacity, size, weight, materials, connection schemes, different numbers of sub-elements, etc.) for various different applications (e.g., extended use, single-use, travel or camping use, etc.), as appropriate. Such structures may include furniture such as seats or stools, storage containers, luggage, tables, ice chest, hampers, toy sets, support elements (e.g., a set of posts or other supports for a bed, table, and/or other appropriate element), etc.

In addition, the structures may be able to be reconfigured in various different ways (e.g., additional and/or substitute components may be provided such that the structure may be adapted to suit various alternative configurations, the components of the structure may be able to be connected in various different ways, etc.).

Some embodiments of the invention provide a modular furniture system including a base component having a cavity and at least one base connector, at least one flexible side panel adapted to connect to the base component, each flexible side panel having at least one first connecting region adapted to be secured to the cavity of the base component and at least one second connecting region, a top support component including a cavity adapted to be secured to the at least one second connecting region, and a lid adapted to be coupled to the top support component.

Alternative embodiments of the invention provide a modular furniture device including a base component including at least one cavity and multiple slots, a top support component including at least one cavity and multiple slots, and at least one side panel, each side panel including multiple connecting regions, each connecting region having multiple connecting elements, each connecting element including a tab adapted to be able to connect to at least one of the slots included in the base component or the top support component.

Other alternative embodiments of the invention provide a method manufacturing a modular furniture structure, the method includes providing a base component, providing at least one flexible side panel capable of being coupled to the base component, providing a top support component capable of being coupled to the at least one flexible side panel, and providing a lid capable of being coupled to the top support component.

The preceding Summary is intended to serve as a brief introduction to some embodiments of the invention. It is not meant to be an introduction or overview of all inventive subject matter disclosed in this document. The Detailed Description that follows and the Drawings (or “Figures” or “FIGS.”) that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matter is not to be limited by the illustrative details in the Summary, Detailed Description and the Drawings, but rather is to be defined by the appended claims, because the claimed subject matter may be embodied in other specific forms without departing from the spirit of the invention.

### BRIEF DESCRIPTION OF THE DRAWINGS

The novel features of the invention are set forth in the appended claims. However, for purpose of explanation, several embodiments of the invention are set forth in the following drawings.

FIG. 1 illustrates a perspective view of a multi-use modular furniture device of some embodiments;

FIG. 2 illustrates an exploded view of some embodiments of the device of FIG. 1;

FIG. 3 illustrates a top view, perspective view and side views of a bottom component of some embodiments of the device of FIG. 1;

FIG. 4 illustrates a front view and perspective view of a side panel of some embodiments of the device of FIG. 1;

FIG. 5 illustrates a side view and an end view of a side panel of some embodiments of the device of FIG. 1;

FIG. 6 illustrates a top view, side view, and perspective view of a top support component of some embodiments of the device of FIG. 1;

FIG. 7 illustrates a top view, side view, and perspective view of a top cover of some embodiments of the device of FIG. 1;

FIG. 8 illustrates a flow chart of a conceptual process used by some embodiments to assemble a modular furniture device; and

FIG. 9 illustrates side views of various different example configurations of the device of FIG. 1.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Several more detailed embodiments of the invention are described in the sections below. Section I provides a conceptual overview of an example structure and used by some embodiments. Section II then describes various components of the structure of some embodiments. Next, Section III describes a method of assembly and/or disassembly provided by some embodiments. Lastly, Section IV describes alternative and/or conjunctive structures and components that may be provided by some embodiments.

### I. Overview

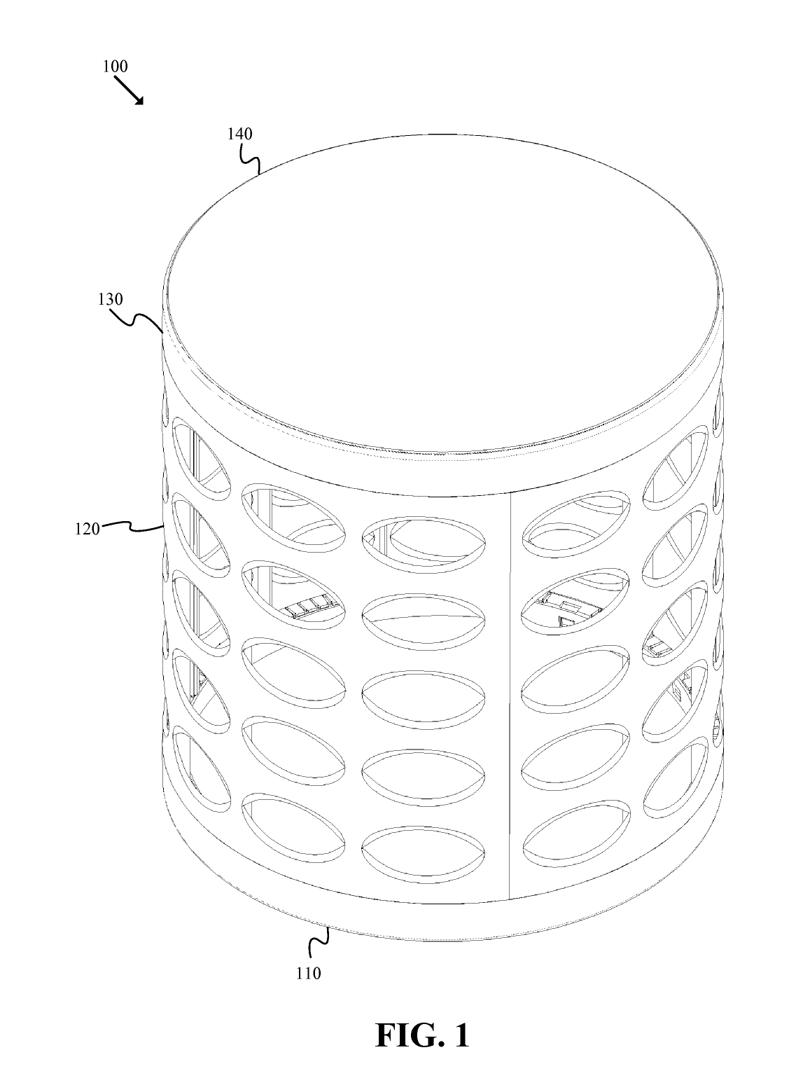

FIG. 1 illustrates a perspective view of a multi-use modular furniture device 100 of some embodiments. Specifically, this figure shows a storage and/or seating device. As shown, the modular furniture device may include a base component 110, at least one side panel 120, a top support component 130, and a lid 140.

The base component 110 may be adapted to provide a supportive platform for the other components of the modular furniture device 100. Each side panel 120 may be adapted to connect to the base component 110 and/or to connect to other side panels 120. As with many (or all) of the connections described throughout, the side panel 120 may form a press fit connection with the base component 110 (and/or other elements), such that the various devices may be formed without need of tools or other such components. Alternatively, a single side panel may be used in some embodiments (in such a case, an edge of the side panel may connect to another opposite edge of the side piece). The top support component 130 may be adapted to connect to the side panel(s) 120 to define a rigid structure. The top support component 130 may be about the same size and shape as the base component 110. The lid 140 may be adapted to be connected to the top support component 130.

Although the various components of the modular furniture device 100 are represented as having particular shapes, structures, and/or other features, one of ordinary skill in the art will recognize that the components may be implemented in various different ways without departing from the spirit of the invention. For instance, although the base component 110 and top support component 130 are shown as being generally circular in shape, different embodiments may include differently shaped base components and/or support components (e.g., an elliptically-shaped, square-shaped, triangular-shaped, etc. base component and/or support component). For embodiments of the device in shapes other than circular, other elements such as corner brackets, edge pieces, and/or any other appropriate element may be used in addition to the above-mentioned components. Furthermore, some embodiments may include additional support components (not shown) that may be adapted to connect to side panels 120 on opposing sides of the support component 130 such that the device may be built to multiple levels and/or other variations.

The various components of the modular furniture device 100 may be made from various appropriate materials and/or combinations of materials. Such materials may be selected to provide a desired combination of design factors such as flexibility, strength, rigidity, weight, cost, etc. The materials may include plastics, metals, polymers, wood, and/or other appropriate materials.

In some embodiments, the components of the device 100 may be made using an injection molding process. In such embodiments, the components may be formed by forcing a molten plastic material into a mold cavity. Such mold cavities may be formed in various appropriate ways (e.g., using computer-controlled machines to create a mold and associated cavity from a metal block and/or other appropriate mold material).

In some embodiments, each component of the device 100 may be capable of forming a generally flat configuration (e.g., the side panels 120 may be laid flat, rather than retain the rounded shape shown in FIG. 1.

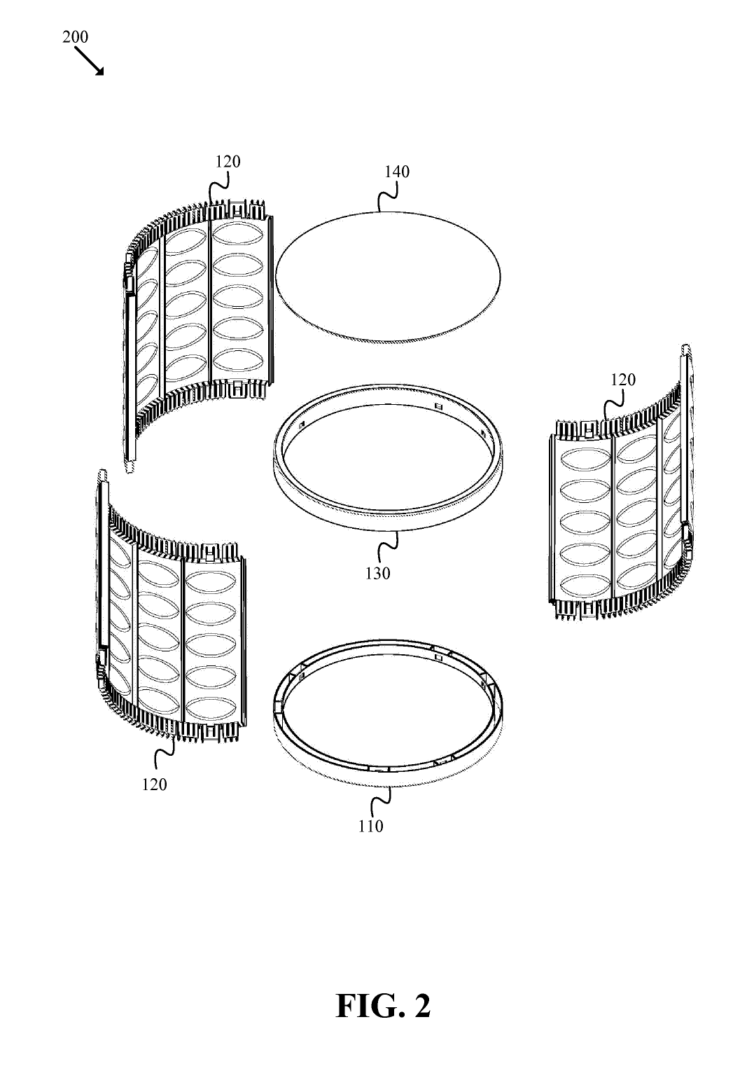

FIG. 2 illustrates an exploded view 200 of some embodiments of device 100. Specifically, this figure shows perspective views of the individual components 110-140 of the device 100 in a dis-assembled state.

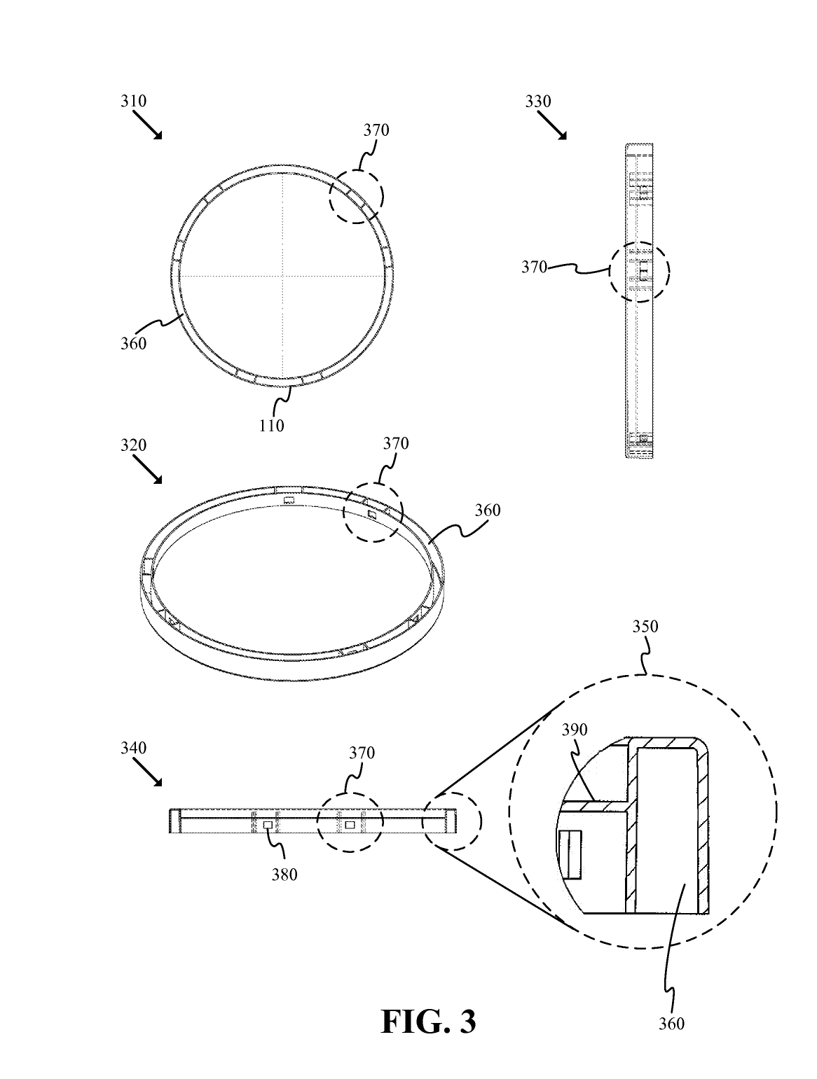

The various components of the modular furniture device 100 will be described in more detail in reference to FIGS. 3-7 below.

### II. Components

FIG. 3 illustrates a top view 310, a perspective view 320, a cross-sectional side view 330, an alternative cross-sectional side view 340, and an expanded view 350 of a portion of the base component 110 of some embodiments. Specifically, this figure shows various elements of the base component that may allow the base component to connect to one or more side panels 120.

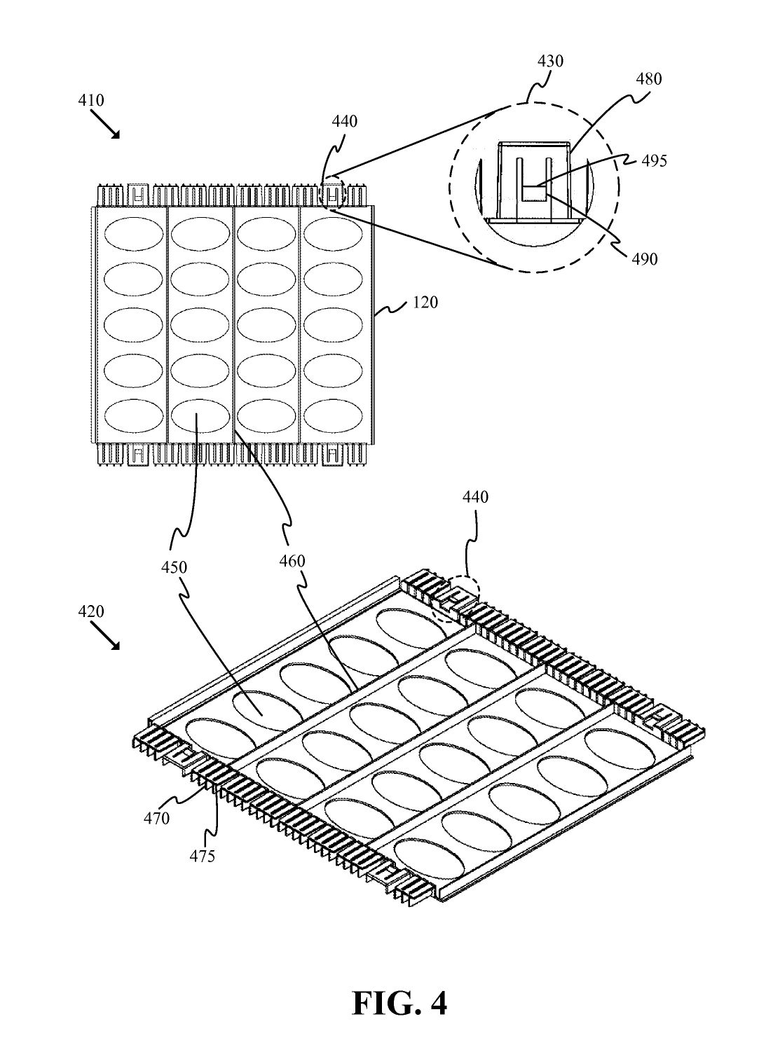

As shown, the base component 110 may include one or more cavities 360 and/or slot(s) 370 (and/or other appropriate connecting element). The cavities 360 may be adapted to receive a portion of an end of a side panel 120 and may be broken into any appropriate number of sections, which may be delineated by any appropriate number of slots 370. The slot 370 and/or other appropriate connector may be adapted to receive a tab and/or other appropriate connector that may include a fastener (and/or otherwise connect using appropriate connecting elements) of a horizontal edge of the side panel 120 (as situated in FIG. 1) in order to secure the side panel to the base component 110 and/or top support component 130. Such connectors and fasteners will also be described in more detail in reference to FIG. 4 below.

As shown, the slot 370 may also include a locking receptacle 380 adapted to secure the fastener in place, when a fastener is included. Such a locking receptacle may be adapted to receive an angled protruding lip of a fastener such that the fastener may be inserted into the slot 370 until the lip engages an edge of the receptacle 380 thus preventing the tab from being removed from the slot and securing the side panel in a fixed position relative to the base component 110 and/or top support component 130. Continuing the example, the fastener may be removed from the slot by pressing an area along the angled protruding lip such that the edge of the lip is disengaged from the receptacle and the fastener may be removed from the slot in order to disassemble the side panel 120 from the base component 110 and/or top support component 130. In this way, the side panels 120 may easily be connected to and/or disconnected from the other components.

The expanded view 350 shows the cavity 360 and a floor 390 of the base component 110 of some embodiments. In addition to providing structural support, the floor 390 may be adapted to close one end of the device 100 such that the interior space of the device may be used for storage. In some embodiments, the floor 390 may be aligned with the bottom of the base component (rather than at a vertical midpoint of the base component).

Although the various elements of the base component 110 are represented as having particular elements, structures, and/or other features, one of ordinary skill in the art will recognize that the components may be implemented in various different ways without departing from the spirit of the invention. For instance, although the base component 110 is shown as having six slots 370 of a certain size and spacing, different embodiments may include a base component 110 having different numbers, sizes, and/or spacings of slots. Alternatively, other embodiments may include fastening elements other than a slot (e.g., a clip, pin, clamp, etc.).

FIG. 4 illustrates a front view 410, a perspective view 420, and an expanded view 430 of a side panel 120 of some embodiments. Specifically, this figure shows the various connecting and structural elements that may be included in some embodiments.

As shown, the side panel 120 may include at least one tab and/or other appropriate connector 440, elliptical holes and/or other decorative elements 450, ribs and/or other support elements 460, raised grooves 470 and/or lowered grooves 475. The expanded view 430 of a portion of the side panel 120 shows a fastener 480 having a tab 490. In this example, the tab includes a protruding lip 495 for securing the fastener to a receptacle (e.g., receptacle 380 described above in reference to FIG. 3).

The side panels may include elliptical holes 450, ribs 460, and/or other decorative and/or structural features, as appropriate. Such ribs may be adapted to provide strength and support to the side panels 120 and to other components connected to the side panels. The ribs and/or other support elements may allow relatively thin and lightweight side panels to support heavy loads. The elliptical holes 450 may be evenly spaced among the ribs 460. While the embodiment in FIG. 4 shows a side panel 120 with twenty circular holes 450, other embodiments may include a different number of holes, differently sized holes, and/or holes of various other shapes including squares, triangles, stars, logos, etc. Alternatively, other embodiments may include a side panel 120 with no holes 450 or other such openings. Some side panels may include printed designs, fabric coverings, and/or other aesthetic elements.

The side panels 120 may include raised grooves 470 and lowered grooves 475 along the horizontally placed edged that may be adapted to connect to other side panels and/or other components. For instance, the raised grooves 470 of one side panel 120 may connect with the lowered grooves 475 of another side panel 120 when directly joining two or more side panels in a vertical orientation. Alternatively, the portions of the edges of the side panel that include the raised and lowered grooves 470-475 may be inserted into cavity 360 of the base component 110 or a similar cavity provided by the top support component 130 or other components (e.g., a link component) to form a press fit connection. In such a configuration, the grooves 470-475 may be adapted to provide structural support to the modular furniture device 100 of some embodiments.

The side panels 120 may also include one or more tabs and/or other appropriate connectors 440 that may be adapted to connect the side panels 120 to each other (e.g., a fastener 440 on a horizontal edge of one side panel may connect to a fastener on a horizontal edge of another side panel), to the base component 110 (e.g., the tab 440 may be inserted into the receptacle 370 described above in reference to FIG. 3), to the top support component 130, and/or to other components (e.g., a link component). The fasteners 440 may include a tab 490 that may lock into place with other components for a more secure connection. As described above, in one exemplary embodiment, three side panels 120 may be connected to each other and to the base component 110 and the top support component 130 to form a hollow cylinder.

Different side panels 120 may have varying heights (e.g., eight inches, sixteen inches, etc.), widths, and/or thicknesses. A single furniture device may include one or more sets of side panels (e.g., a furniture device may have one set of sixteen inch side panels while another furniture device may have one set of sixteen inch side panels and one set of eight inch side panels).

In some embodiments, a link component (not shown) may include multiple cavities and/or other connection elements to allow the link component to join a first set of side panels to a second set of side panels. In such an arrangement, for example, the first set of side panels may form a base for the link component, and the second set of side panels may extend upward from the link component. The link component may include multiple sets of press fit ribs and/or grooves, as appropriate, such that the link component may couple to each side panel.

Although the various elements of the side panel 120 are represented as having particular shapes, structures, and/or other features, one of ordinary skill in the art will recognize that the components may be implemented in various different ways without departing from the spirit of the invention. For instance, while the side panel 120 is shown as having five vertical support ribs 460 in the body of the panel, other embodiments may include a different number of ribs and/or ribs that are configured at various different angles relative to the edges of the side panel 120. Alternatively, some embodiments may include side panels with other support structures (e.g., beams, arches, etc.) and/or solid panels that are made of a sufficiently rigid and strong material (e.g., plastics, metals, polymers, and/or other appropriate materials having a thickness capable of supporting the desired load). As another alternative, in some embodiments the side panels may have a modified lattice structure (e.g., vertical members coupled to angular member to form a side panel with triangle-shaped openings). Also, while some embodiments of the device have been described as forming a cylinder by combining three side panels to each other and to a base component 110 and a top support component 130, other embodiments may include a smaller or larger number of side panels 120 (or even a single side panel that forms a cylinder or other shape by wrapping around to connect one edge of the panel to an opposite edge of the same panel using a tongue and groove connection, for example).

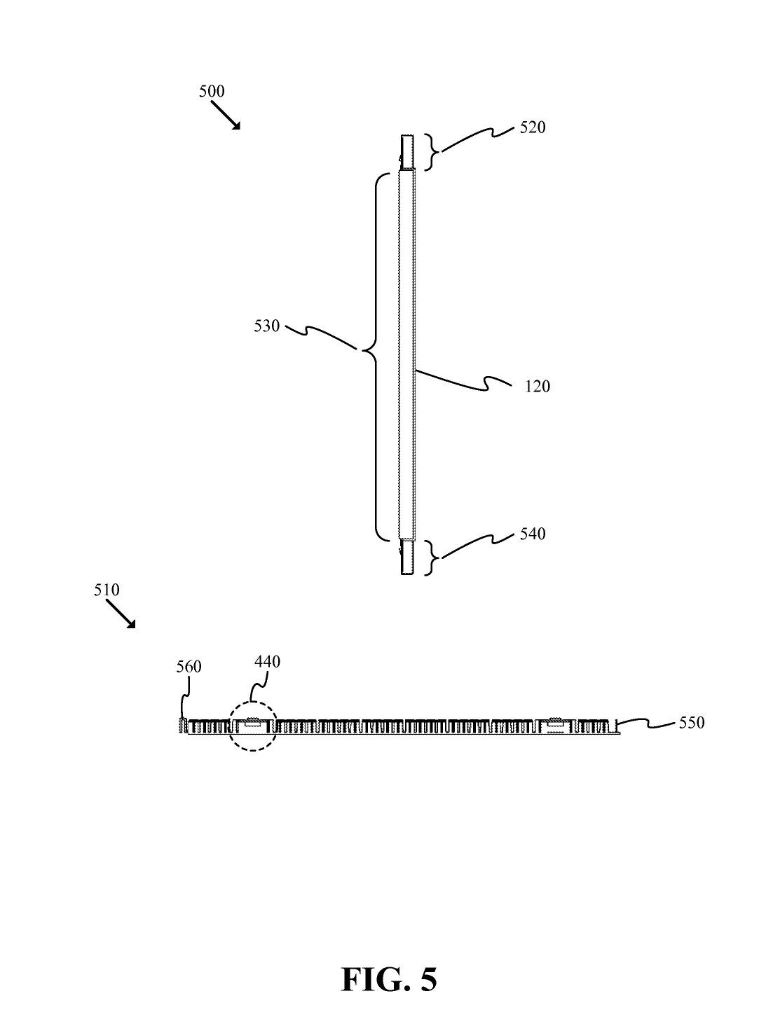

FIG. 5 illustrates a side view 500 along a vertical axis and an end view 510 along a horizontal axis of a side panel 120 of some embodiments. Specifically, this figure shows various elements that may be used to connect the side panel to a base component and/or top support component of some embodiments.

As shown in side view 500, the side panel 120 may include a first connecting region 520, a structural region 530, and a second connecting region 540. The first connecting region may be, for example, adapted to connect to one or more base components 360, as appropriate.

The structural region 530 may provide structural support for the side panels 120. As described above in reference to FIG. 4, the structural region 530 may include various elements, including ribs, solid panels, lattice structures, etc., that are capable of supporting an appropriate load.

The second connecting region 540 may be, for example, adapted to connect to one or more top support components 130, as appropriate.

During assembly, the first connecting region 520 may be inserted into the cavities 360 and/or slots 370 to connect the base component 110 (and/or otherwise be appropriately connected). Likewise, the second connection region 540 may be connected to the top support component 130.

As shown in end view 510, side panel 120 may include a first connector component 550 (e.g., a “tongue”) and a second, complementary, connector component 560 (e.g., a “groove”). The first component 550 and second component 560 may be used to connect side panels 120 to each other (or to connect one vertical edge of a side panel to another vertical edge of the same side panel). For instance, when the side panels are connected to form a cylinder, a first connector component 550 of one side panel 120 may be adapted to receive (or otherwise connect to) a second connector component 560 of another (or the same) side panel 120 to form a secure connection. Such first and second connector components 550-560 may be configured in various ways, as appropriate. For instance, in some embodiments a set of pins may be provided that align with an associated set of sockets. The pins may thus be inserted into and secured with the sockets. The first component 550 and the second component 560 may be adapted to form a flush or seamless connection (e.g., the exterior surface of the furniture device may follow a smooth curve). As in the example of FIG. 5, the first and second components 550-560 may be male/female components, and/or may include other appropriate types of connectors.

Although the various elements of the side panel 120 are represented as having particular shapes, structures, and/or other features, one of ordinary skill in the art will recognize that the components may be implemented in various different ways without departing from the spirit of the invention. For instance, while the side panels 120 are described as being able to form a cylinder with a bottom component 110 and a top support component 130, other embodiments may include side panels 120 composed of a flexible material or lattice structure that may allow the side panel to form various other shapes. For example, the side panels may be adapted to connect with a base component 110 and a top support component 130 such that the bottom circumference and top circumference of the device are different sizes, forming a cone-like structure. Furthermore, other embodiments may include a base component 110 and top support component 130 that may connect with one or more side panels 120 to form various other shapes and/or structures.

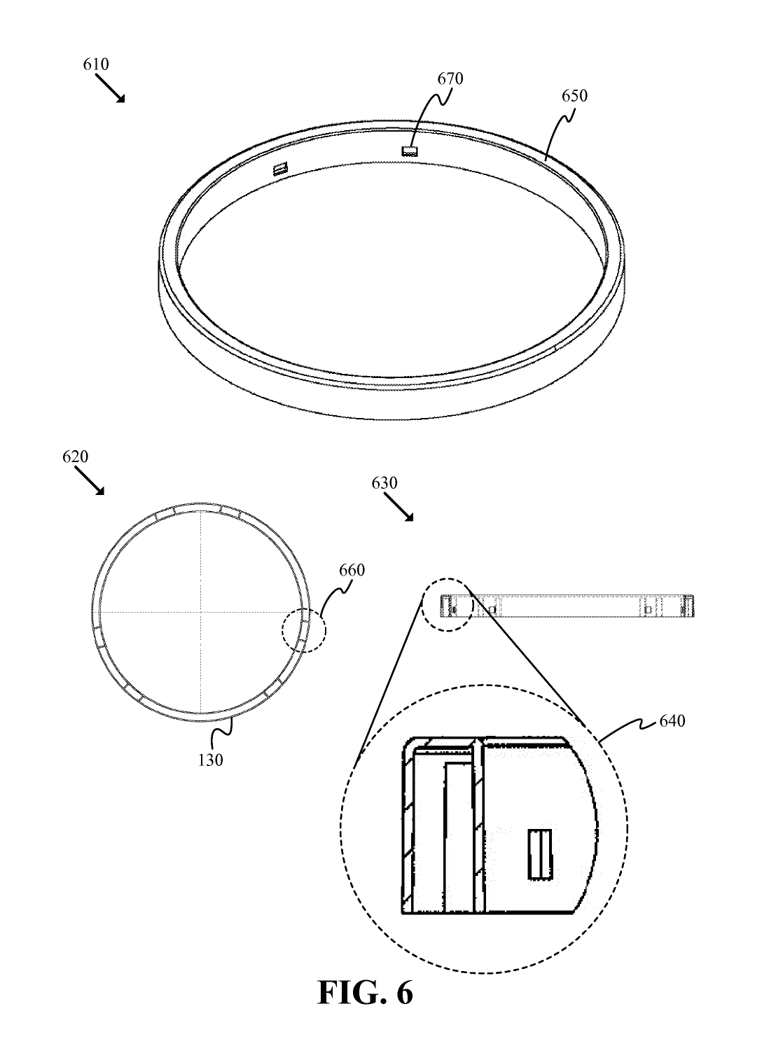

FIG. 6 illustrates a perspective view 610, top view 620, cross-sectional side view 630, and expanded view 640 of a top support component 130 of some embodiments. Specifically, this figure shows various elements of the top support component that may allow the top support component to connect to one or more side panels 120.

As shown, the top support component 130 may include one or more cavities 650 and/or slots 370 (and/or other appropriate connecting elements). The cavities 650 may be adapted to receive a portion of an end of a side panel 120 and may be broken into any appropriate number of sections, which may be delineated by any appropriate number of slots 660. The slot 660 and/or other appropriate connector may be adapted to receive a tab and/or other appropriate connector that may include a fastener (and/or otherwise connect using appropriate connecting elements) 670 of a horizontal edge of the side panel 120 (as situated in FIG. 1) in order to secure the side panel to the top support component 130. Such connectors and fasteners were described in more detail in reference to FIG. 4 above.

As shown, the slot 660 may also include a locking receptacle 670 adapted to secure the fastener in place, when a fastener is included. Such a locking receptacle may be adapted to receive an angled protruding lip (e.g., lip 495 of flexible tab 490 as described above in reference to FIG. 4) of a fastener such that the fastener may be inserted into the slot 660 until the lip engages an edge of the receptacle 670 thus preventing the tab from being removed from the slot and securing the side panel in a fixed position relative to the base component 110 and/or top support component 130. Continuing the example, the fastener may be removed from the slot by pressing an area along the angled protruding lip such that the edge of the lip is disengaged from the receptacle and the fastener may be removed from the slot in order to disassemble the side panel 120 from the base component 110 and/or top support component 130. In this way, the side panels 120 may easily be connected to and/or disconnected from the other components.

The expanded view 640 shows the cavity 650 of the top support component 130 of some embodiments. As described above, a link component of some embodiments may include a cavity similar to cavity 650 on opposite sides of the link component such that the link component may join two sets of side panels (e.g., from the top and bottom).

Although the various elements of the top support component 130 are represented as having particular sub-elements, structures, and/or other features, one of ordinary skill in the art will recognize that the components may be implemented in various different ways without departing from the spirit of the invention. For instance, although the top support component 130 is shown in FIG. 6 to be circular, other embodiments may include support components in other shapes such as a square, triangle, hexagon, etc. Furthermore, some embodiments may include a variety of support components of different shapes and/or sizes adapted to form an assortment of structures and/or adapted to connect to one or more side panels 120 and/or other components by one or more types of connectors and/or fasteners.

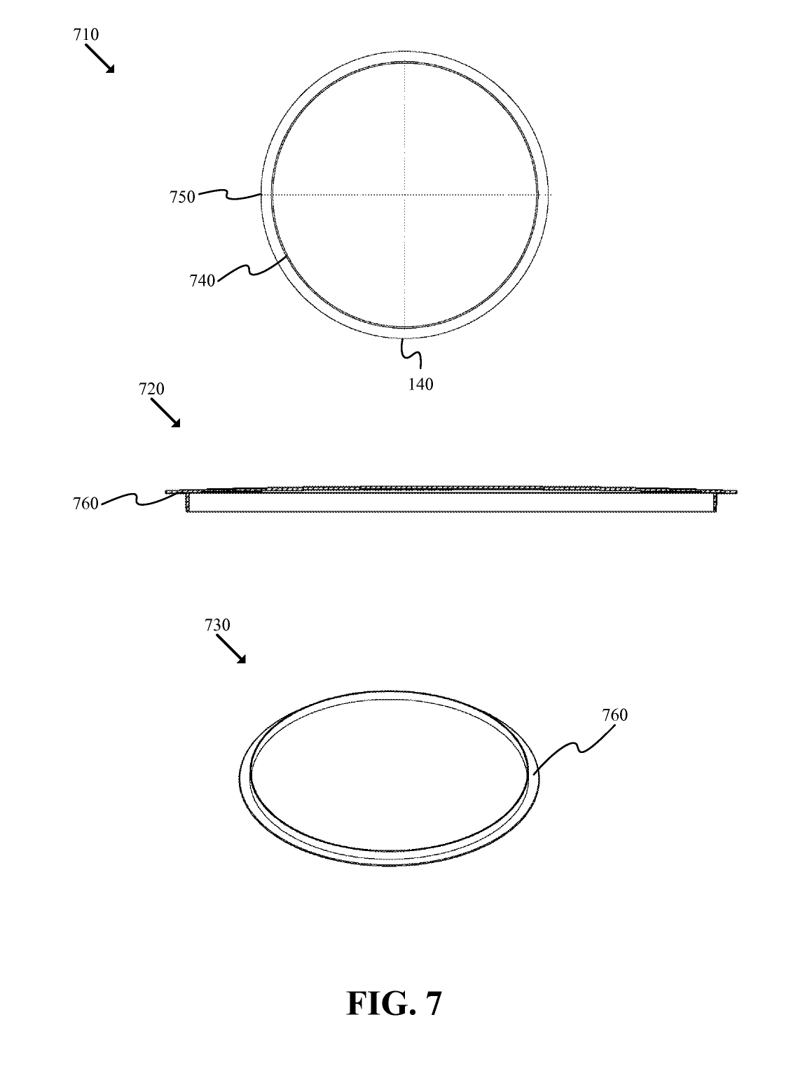

FIG. 7 illustrates a bottom view 710, side view 720, and perspective view 730 of a lid 140 of some embodiments. Specifically, this figure shows various elements of the lid that may allow the lid to connect to top support component 130, as appropriate. As shown, in this example the lid has an inner section or circumference 740, an outer section or circumference 750, and a lip 760.

The inner circumference 740 and outer circumference 750 of the lid 140 may form a lip 760 that may be adapted to fit within a top support component 130. In some embodiments, the lid 140 may fit tightly inside the top support component 130 without locking into place, allowing for easy removal, although in other embodiments the lid 140 may include fasteners, levers, grooves, clips, etc. to lock into place with the top support component 130 and/or other components. The lid 140 may be the same circumference as the base component 110 so that the device forms a cylinder, although other embodiments may include devices with other shapes, sizes, and/or dimensions. In some embodiments, the lid 140 may include a recess, cavity, and/or other appropriate elements that may be adapted to fit a seat, cushion, additional components of the device, etc. Alternatively, some embodiments may include a seat or other appropriate element (e.g., a game board) in place of the lid. In such cases, the seat may couple to the top support component 130 and may include a ribbed connection similar to a lid. In addition, the lid may include a handle to place and remove the lid from the device.

Although the various components of the lid 140 are represented as having particular shapes, structures, and/or other features, one of ordinary skill in the art will recognize that the components may be implemented in various different ways without departing from the spirit of the invention. For instance, while the lid 140 is described as being able to fit within a top support component 130, other embodiments may include a lid that rests on the tops support component and/or is otherwise coupled to the top support component. For example, the lid may screw into a threaded opening in the top support component. In addition, in some embodiments, the lid and/or top support component 130 may be used in place of a base component 110.

III. Method of Assembly and/or Disassembly

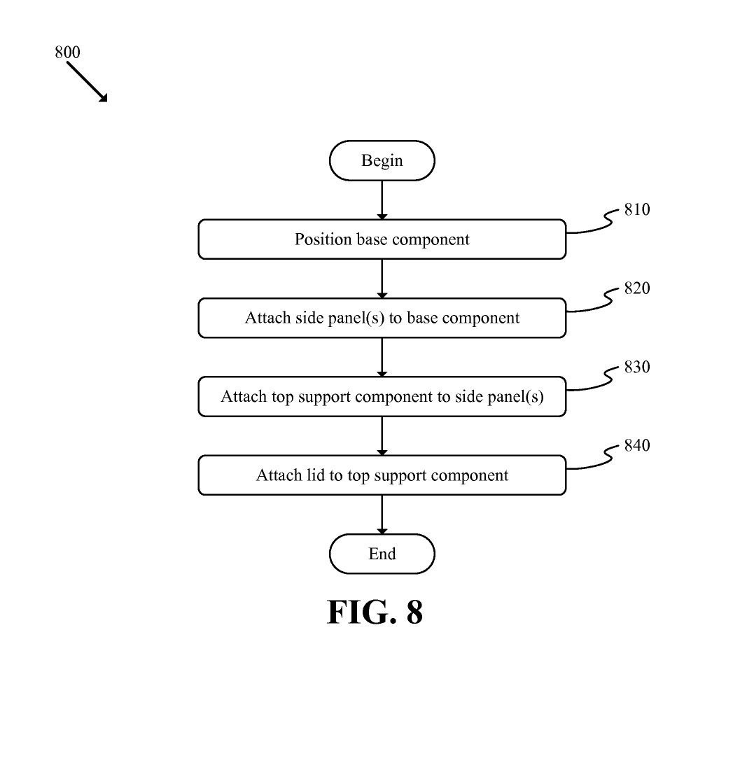

FIG. 8 illustrates a flow chart of a conceptual process 800 used by some embodiments to assemble a modular furniture device (e.g., device 100). The process may begin when a user or manufacturer begins assembly of a device.

Next, the process positions (at 810) the base component. Such positioning may involve, for instance, placing the bottom surface of the base component on a flat, stable surface such as a floor, table, or countertop. Next, the process may attach (at 820) one or more side panels to the base component. Such attachment may be performed in various appropriate ways, for instance as described above in reference to FIGS. 3-5.

The process may then attach (at 830) a top support component to the side panels. The components may be attached in various appropriate ways, as described above in reference to FIGS. 4-6.

Process 800 may then attach (at 840) a lid to the top support component. Such attachment may be performed as described above in reference to FIG. 7.

One of ordinary skill in the art will recognize that process 800 may be performed in various appropriate ways without departing from the spirit of the invention. For instance, the process may be performed using various different operations. In addition, the operations may be performed in various different orders. Furthermore, the process may be broken up into various sub-processes and/or performed as part of one or more macro processes, as appropriate.

IV. Alternative and/or Additional Structures and/or Components

In addition to, or in place of, various feature and/or components described above, some embodiments may include alternative and/or additional features, as appropriate.

For instance, in some embodiments the lid 140 described above may include various alternative and/or additional elements such as table tops, seats, connectors, liners, etc. Such table tops may include round, square, and otherwise shaped table tops. Such seats may include various appropriate support structures and/or cushioning, as appropriate. For instance, in some embodiments the lid may include various connection elements (e.g., one or more connecting holes, receptacles, and/or other appropriate elements that may receive and/or otherwise interface with complementary elements from the alternative and/or additional elements to securely attach the additional element(s) to the provided structure).

Furthermore, various elements may be arranged in various different ways. For instance, a number of modules could be stacked (using linking components in place of at least some top support components, and or by configuring base components to fit within openings provided by various top support components, etc.).

In addition, structural regions of lattice-type side panels may include multiple pin and socket type connectors that may be adapted to allow sections of the side panels to be interlocked with associated sections of one or more other side panels, as appropriate.

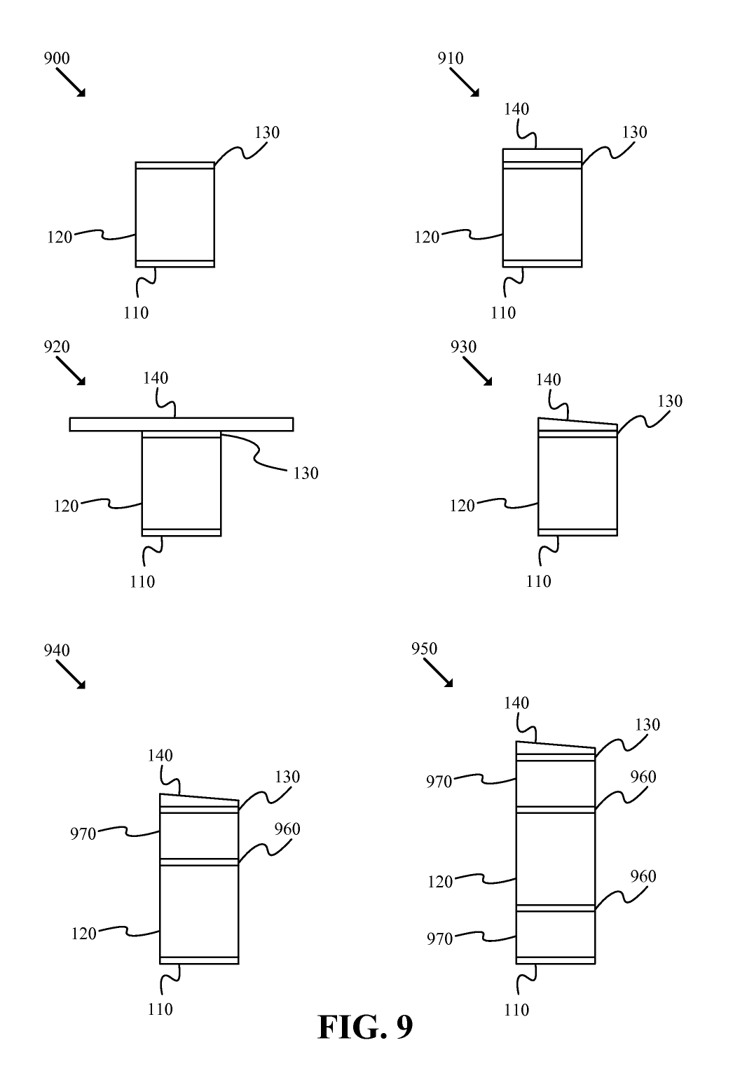

FIG. 9 illustrates side views 910-950 of various different example configurations of device 100. Specifically, this figure shows various example connection schemes using a limited number of components.

Side view 900 illustrates a device 100 that includes a base component 110, at least one side panel 120, and a top support component 130. In this example, the device 100 has no lid, such that the top is open (e.g., the device may serve as a wastebasket, storage bin, and/or other appropriate device having an open top).

Side view 910 illustrates a device 100 that includes a base component 110, at least one side panel 120, a top support component 130, and a lid 140. In this example, the lid 140 has a structural thickness such that the lid may serve as a table top or other such element.

Side view 920 illustrates a device 100 that includes a base component 110, at least one side panel 120, a top support component 130, and a lid 140. In this example, the lid 140 has a structural thickness such that the lid may serve as a table top or other such element and the surface of the lid has a larger radius (or other appropriate dimension) than the other components of the device.

Side view 930 illustrates a device 100 that includes a base component 110, at least one side panel 120, a top support component 130, and a lid 140. In this example, the lid 140 serves as a seat for a stool or chair.

Side view 940 illustrates a device 100 that includes a base component 110, at least one side panel 120, a top support component 130, a lid 140, a link component 960, and at least one alternative side panel 970. In this example, each alternative side panel has a different height than the at least one side panel 120. Such differently-sized elements, allows for configurations to match various user needs.

Side view 950 illustrates a device 100 that includes a base component 110, at least one side panel 120, a top support component 130, a lid 140, link components 960, and first and second sets of alternative side panels 970. In this example, each alternative side panel has a different height than the at least one side panel 120. Such differently-sized elements, allows for configurations to match various user needs (e.g., the stools or chairs of various height shown in side views 930-950).

In addition to the examples of FIG. 9, one of ordinary skill in the art will recognize that various other configurations may be used. For instance, in some embodiments a device may include one or more inner support structures that each may include a base component, a set of side panels, and a top support component (and/or other components such as link components or sets of alternative side panels) and one or more outer support structures that each include similar components. Such a multi-support structure may form devices (e.g., tables) that are able to support larger loads than support structures with single support structures.

Furthermore, other embodiments may be configured to provide a liner around the interior portion of the side panels which may accept an ice chest to be fitted on the inside or alternatively as a hamper or other such device. The top lid may also be configured with popular game boards (such as checkers, chess, tic-tac-toe, etc.) where the interior of the modular furniture may be used to store the game pieces. With the ease of use in re-configuring the modular furniture of the present invention, a user may be able to use it as storage and then easily replace the top with a seat cushion, the interior with an ice chest, a top that is larger than the base to provide a table for outdoor or indoor use, and/or other appropriate components.

While the invention has been described with reference to numerous specific details, one of ordinary skill in the art will recognize that the invention can be embodied in other specific forms without departing from the spirit of the invention. For example, several embodiments were described above by reference to particular features and/or components (e.g., connecting three side panels to each other and to the bottom piece and the connector ring to form a hollow cylinder, using the top cover as a lid for storage or as the base of a seat, having a side panel with structural support ribs and holes between the ribs, etc.). However, one of ordinary skill in the art will realize that other embodiments might be implemented with other types of features and components (e.g., connecting a larger or smaller number of side panels, forming a different shape, using a connector link as an intermediary piece for a different type of structure, having a side panel with a lattice support structure, and/or alternatively with artwork, graphic design, fabrics, and/or other printed material(s) attaches to the device, etc.). One of ordinary skill in the art would understand that the invention is not to be limited by the foregoing illustrative details, but rather is to be defined by the appended claims.

We claim:

1. A modular furniture system comprising:
a base component comprising a cavity and at least one base connector;
at least one flexible side panel adapted to connect to the base component, each flexible side panel comprising at least one first connecting region adapted to be secured to the cavity of the base component and at least one second connecting region;
a top support component comprising a cavity adapted to be secured to the at least one second connecting region; and
a lid adapted to be coupled to the top support component.

2. The modular furniture system of claim 1, wherein each base connector comprises at least one slot and locking receptacle.

3. The modular furniture system of claim 2, wherein the at least one first connecting region comprises a flexible tab and a protruding lip, the protruding lip adapted to engage with an edge of the locking receptacle to secure the at least one first connecting region to the at least one base connector.

4. The modular furniture system of claim 1, wherein the lid is a seat cushion comprising a press-fit connector for coupling the lid with the top support component.

5. The modular furniture system of claim 1 further comprising a seat element adapted to be coupled to the lid.

6. The modular furniture system of claim 1, wherein the base component, each side panel, the top support component and the lid may be disassembled from each other into flat modular pieces for transportation or storage during non-use.

7. The modular furniture system of claim 1, wherein each side panel comprises a plurality of support ribs adapted to allow heavy loads to be supported by the side panel.

8. A modular furniture device comprising:
a base component including at least one cavity and a plurality of slots;
a top support component including at least one cavity and a plurality of slots; and
at least one side panel, each side panel including a plurality of connecting regions, each connecting region having a plurality of connecting elements, each connecting element comprising a tab adapted to be able to connect to at least one of the plurality of slots included in the base component or the top support component.

9. The modular furniture device of claim 8 further comprising a lid adapted to be coupled to the top support component.

10. The modular furniture device of claim 8, wherein the base component comprises a rigid floor adapted to seal one end of the modular furniture device.

11. The modular furniture device of claim 8 further comprising a link component, wherein the link component comprises a first and second link cavity configured to allow a first set of side panels to be coupled to the first link cavity and a second set of side panels to be coupled to the second link cavity.

12. The modular storage device of claim 8, wherein each side panel comprises a set of support ribs.

13. The modular storage device of claim 9, wherein each side panel comprises a set of cut-outs, wherein the set of cut-outs forms a particular aesthetic design for each side panel.

14. The modular storage device of claim 8, wherein each side panel comprises a tongue connector and a groove connector, wherein the tongue connector allows a seamless connection to be made with the groove connector.

15. A method of manufacturing a modular furniture structure, the method comprising:
providing a base component;
providing at least one flexible side panel capable of being coupled to the base component;
providing a top support component capable of being coupled to the at least one flexible side panel; and
providing a lid capable of being coupled to the top support component.

16. The method of claim 15 further comprising providing a first connecting region on each flexible side panel that is capable of being coupled to a corresponding cavity on the base component.

17. The method of claim 16, wherein the corresponding cavity includes a set of slots adapted to receive an associated set of tabs from the flexible side panel.

18. The method of claim 15, wherein the top support component is configured to attach to the at least one flexible side panel by inserting a second connecting region of the at least one flexible side panel into a corresponding cavity of the top support component.

19. The method of claim 18, wherein the corresponding cavity of the top support component comprises a set of slots adapted to receive an associated set of tabs from the flexible side panel.

20. The method of claim 15, wherein each flexible side panel includes a first connector component and a second connector component adapted such that each side panel is able to couple to at least one other side panel along a vertical edge of each side panel.
